(19) United States
(12) Patent Application Publication
(10) Pub. No.: US 2024/0399963 A1
(43) Pub. Date: Dec. 5, 2024

(54) VEHICLE RUNNING BOARD

(71) Applicant: Toneluck Product Technology (Huizhou} Co., Ltd., Huizhou City, Guangdong (CN)

(72) Inventor: Tsz Hung Rabi WONG, Huizhou City, Guangdong (CN)

(21) Appl. No.: 18/273,789

(22) PCT Filed: Jan. 29, 2023
(86) PCT No.: PCT/CN2023/073659

§ 371 Date: Jul. 24, 2023

(30) Foreign Application Priority Data
Jan. 28, 2022 (CN) 202210105411.1

(51) Int. Cl. B60R 3/02

(52) U.S. Cl. CPC B60R 3/02

(57) ABSTRACT

The present disclosure discloses a vehicle running board. The vehicle running board includes a pair of swing arms, a movable bracket, a running board bracket, an exciting member and a running board body; the movable bracket is connected to the pair of swing arms, and is configured to make extension or retraction motion between a retraction position and an extension position; the running board bracket is movably connected to the movable bracket, and is rotatable around an axis under the exciting action of the exciting member; and the running board body is disposed on the running board bracket. When the running board body extends out, the running board body can be turned over upwards and swing close to a vehicle body with respect to the movable bracket under the condition that a side face bears external forces or collides with foreign matter.

### BACKGROUND OF THE INVENTION

The present disclosure relates to the technical field of vehicle accessories, in particular to a vehicle running board.

Vehicles such as off-road vehicles and SUVs have a high chassis, and when people get on or off the vehicles, they need to take a large step between a carriage and the ground. Therefore, running boards are generally mounted on the vehicles such as off-road vehicles and SUVs, and when people get on or off the vehicles, they can step on the running boards as a transition to get on or off the vehicles conveniently.

Since a running board is mainly used by people to step on for getting on or off a vehicle from the outside of the vehicle, a vehicle running board currently used is mainly an electric running board with a retractable function, that is, the running board may extend to the outside of a vehicle body for people to step on for getting on or off, and may retract to the bottom of the vehicle when not in use. However, the vehicle running board currently used is directly fixedly connected to a running board bracket, and the running board bracket is directly connected to swing arms. For example, in a horizontally retractable vehicle running board disclosed by the Chinese patent No. CN106240478B, the running board extends and retracts synchronously with the running board bracket, and the running board is still kept basically horizontal relative to the ground after being retracted. For such vehicle running board, there is a large gap between the running board and the vehicle body after the running board is retracted, and the running board may not fit with a bottom of the vehicle body. Besides, the running board has a low relative height due to the large gap, and also has the risk of colliding with foreign matter such as a high curbstone in the running process. Moreover, as the running board has a certain extension length relative to the outside of the vehicle body, and is still kept basically horizontal after being retracted, the whole vehicle running board needs to be disposed at a position deep enough at the bottom of the vehicle in order to ensure that the running board is well hidden, which increases the mounting difficulty of the whole vehicle running board and reduces the aesthetics of the mounted vehicle running board. In addition, for such vehicle running board, after the running board extends out, when subjected to external forces such as collision with foreign matter, the running board fixedly connected to the running board bracket may not make cushioning actions such as turnover or retraction, but directly bear the external action force, so the running board is prone to being damaged, and accordingly the service life of the running board is affected.

### BRIEF SUMMARY OF THE INVENTION

In order to solve the problem that in the prior art, when a vehicle running board is retracted, there is a large gap between a running board tread and a vehicle body, and the vehicle running board is prone to bearing external impact when extending out, which affects the service life, the present disclosure provides a vehicle running board.

The object of the present disclosure is implemented through the following Technical solutions.

A vehicle running board includes a first swing arm, a second swing arm, a movable bracket, a running board bracket, an exciting member, and a running board body;
when in use, a first end of the first swing arm and a first end of the second swing arm are rotatably attached to a vehicle, the first end of the first swing arm being rotatable around a first axis, and the first end of the second swing arm being rotatable around a second axis; the movable bracket is connected to a second end of the first swing arm and a second end of the second swing arm, and is rotatable around a third axis and a fourth axis respectively with respect to the first swing arm and the second swing arm; the movable bracket is configured to make extension or retraction motion between a retraction position and an extension position;
the running board bracket is movably connected to the movable bracket, and is rotatable around a fifth axis under the exciting action of the exciting member; and the running board body is disposed on the running board bracket.

As a preferred implementation solution, the vehicle running board further includes a fixed bracket; when in use, the first swing arm and the second swing arm are attached to the vehicle through the fixed bracket; and the first end of the first swing arm and the first end of the second swing arm are movably connected to the fixed bracket and are rotatable around the first axis and the second axis respectively.

As a preferred implementation solution, in the vehicle running board according to any one of the above, the exciting member corresponds to a first end of the running board bracket, and the running board body is disposed at a second end of the running board bracket; the first end and the second end of the running board bracket are rotatable around the fifth axis; and the exciting member acts on the first end of the running board bracket to drive the running board bracket to rotate.

Further, when the running board bracket moves along with the movable bracket from the extension position to the retraction position, the exciting member abuts against the first end of the running board bracket to enable the running board bracket to rotate around the fifth axis.

As a preferred implementation solution, a first end of the running board bracket has an exciting action arm, and the running board body is disposed at a second end of the running board bracket; and when the running board bracket moves along with the movable bracket from the extension position to the retraction position, the exciting action arm moves close to the exciting member and abuts against the exciting member, and the exciting member drives the running board bracket to rotate around the fifth axis.

Further, the exciting member is fixed.

Further, a surface, in contact with the exciting action arm, of the exciting member is a curved surface.

Further, a surface, in contact with the exciting action arm, of the exciting member is a curved convex surface.

As a more preferred implementation solution, the vehicle running board according to any one of the above further includes a fixed bracket; when in use, the first swing arm and the second swing arm are attached to the vehicle through the fixed bracket; and the first end of the first swing arm and the first end of the second swing arm are connected to the fixed bracket and are rotatable around the first axis and the second axis respectively.

Further, the exciting member is located on the fixed bracket.

Further, the exciting member is a raised structure integrated with the fixed bracket on the fixed bracket.

As a more preferred implementation solution, the movable bracket has an avoidance position to avoid swinging of the exciting action arm.

As a preferred implementation solution, the above-mentioned vehicle running board further includes a rotation drive member, the rotation drive member being capable of driving the running board bracket to rotate around the fifth axis.

As a preferred implementation solution, in the vehicle running board according to any one of the above, the movable bracket and the running board bracket are provided with corresponding abutting surfaces; and when the running board bracket extends out in place, the movable bracket abuts against the running board bracket.

As a preferred implementation solution, in the vehicle running board according to any one of the above, the movable bracket is provided with a mounting portion extending towards the running board bracket, and the running board bracket is movably mounted on the mounting portion of the movable bracket.

As a preferred implementation solution, the vehicle running board according to any one of the above further includes a swinging drive member, the swinging drive member being capable of driving the first swing arm or the second swing arm to rotate and swing.

Compared with the prior art, the present disclosure has the following advantages and beneficial effects:

According to the vehicle running board of the present disclosure, the running board body is connected to the movable bracket through the running board bracket capable of rotating and moving with respect to the movable bracket, so that when the running board body extends out, the running board body may be turned over upwards and swing close to a vehicle body with respect to the movable bracket under the condition that a side face bears external forces or collides with foreign matter, so that the running board body may be turned over for cushioning when subjected to external forces instead of bearing direct impact of the external forces, thereby reducing two-way damages to the running board body and a collision object and prolonging the service life of the running board body.

In addition, the exciting member is further provided, and when the running board body retracts, the exciting member may excite the running board bracket where the running board body is connected and disposed, so as to drive the running board body to tilt upward to retract in place, so that the running board body is closer to a bottom side face of the vehicle body when retracting in place, and is prevented from being damaged due to collision with obstacles in the running process, and the overall appearance of the retracted running board body and the vehicle body is improved. In addition, as the running board body may tilt upward to be close to the bottom side face of the vehicle body after retracting in place, the running board body may be well hidden. Moreover, the whole vehicle running board does not need to be mounted deep into the vehicle bottom, so that the mounting difficulty of the whole vehicle running board is reduced, and the aesthetics of the mounted vehicle running board is improved.

### BRIEF DESCRIPTION OF THE DRAWINGS

FIG. 1 is a schematic structural diagram of a vehicle running board according to specific embodiments of the present disclosure.

FIG. 2 is a schematic assembly structure diagram of a vehicle running board according to specific embodiments of the present disclosure.

FIG. 3 is a schematic structural diagram of a vehicle running board in an extended state according to specific embodiments of the present disclosure.

FIG. 4 is a schematic cross-sectional view of a vehicle running board in an extended state according to specific embodiments of the present disclosure.

FIG. 5 is a schematic structural diagram of a vehicle running board in a retracted state according to specific embodiments of the present disclosure.

FIG. 6 is a schematic cross-sectional view of a vehicle running board in a retracted state according to specific embodiments of the present disclosure.

Reference numerals: 1-Fixed bracket, 2-First swing arm, 3-Second swing arm, 4-Movable bracket, 401-First abutting bearing surface, 402-First auxiliary bearing surface, 403-Mounting portion, 404-Avoidance position, 5-Running board bracket, 501-Second abutting bearing surface, 502-Second auxiliary bearing surface, 503-Exciting action arm, 6-First rotating shaft, 7-Second rotating shaft, 8-Third rotating shaft, 9-Fourth rotating shaft, 10-Fifth rotating shaft, 11-Running board body, 1101-Running board tread, 12-Exciting member, and 13-Slider.

### DETAILED DESCRIPTION OF THE INVENTION

The technical solutions of the present disclosure are described in further detail below in conjunction with specific embodiments and the accompanying drawings, but the scope of protection and implementation of the present disclosure are not limited thereto.

In the description of specific embodiments, it should be noted that the terms “up”, “down”, “left”. “right”, “front”, “back”, etc. indicate the orientation or position relationship based on the orientation or position relationship shown in the accompanying drawings or the orientation or position relationship in which the product of the present disclosure is customarily placed in use, and that the terms “first”. “second”, etc., are for ease of differentiation and are intended only to facilitate and simplify the description of the present disclosure, and are not intended to indicate or imply that the structures or components referred to must have a particular orientation, be constructed and operate in a particular orientation, and therefore are not to be construed as limiting the present disclosure, let alone indicating or implying relative importance.

Unless otherwise expressly specified and limited, the terms “mounted”, “disposed”, “connected”, “fixed”, etc., are to be understood in a broad sense. For example, they may be fixed connections, removable connections, or integral connections; they may be mechanical connections or electrical connections; they may be direct connections or indirect connections through an intermediate medium; or they may be internal connections of two components or interactions of two components. The specific meanings of the above terms in the present disclosure may be understood by a person of ordinary skill in the art according to specific circumstances. In addition, when the term “and/or” is used, all references herein are to any and all combinations including one or more of the relevant listed items.

A vehicle running board according to the present disclosure is attached to a vehicle for use. Specifically, the vehicle running board may be attached to a chassis of the vehicle, and may extend from underneath the chassis of the vehicle to the outside of a vehicle body during operation, so as to form a step structure for a person to step on to get on or off the vehicle.

The vehicle running board may specifically be attached to a side of a length direction of the vehicle, such as a rear of the vehicle, or may be attached to a side of a width direction of the vehicle, such as a left side and a right side of the vehicle.

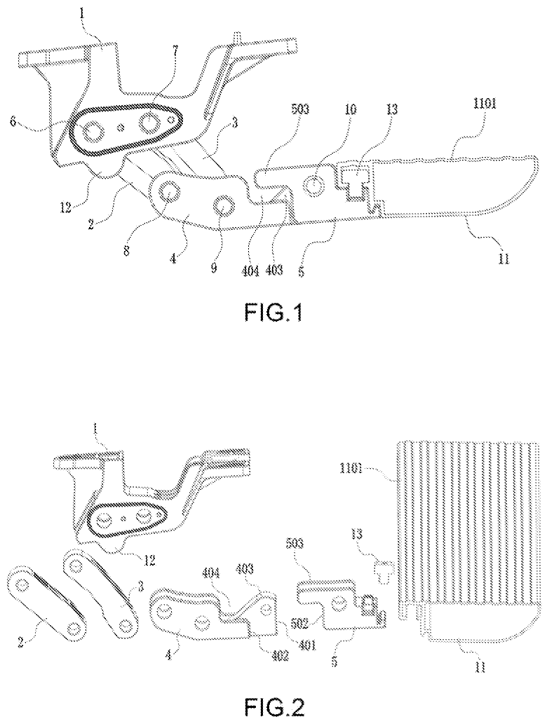

As shown in FIG. 1 and FIG. 2, a vehicle running board is provided with a pair of arms, a running board bracket 5, and a running board body 11. The pair of arms specifically include a first swing arm 2 and a second swing arm 3. Each of the first swing arm 2 and the second swing arm 3 is provided with a first end and a second end. The first end of the first swing arm 2 corresponds to the first end of the second swing arm 3, and the second end of the first swing arm 2 corresponds to the second end of the second swing arm 3. The first end of the first swing arm 2 and the first end of the second swing arm 3 are configured to be attached to a vehicle when in use. The first end of the first swing arm 2 is connected and mounted specifically through a first rotating shaft 6, and the first end of the second swing arm 3 is connected and mounted specifically through a second rotating shaft 7, so that the first end of the first swing arm 2 and the first end of the second swing arm 3 are rotatable around axes where the first rotating shaft 6 and the second rotating shaft 7 are located, respectively. When the first end of the first swing arm 2 and the first end of the second swing arm 3 rotate around the axes where the first rotating shaft 6 and the second rotating shaft 7 are located, respectively, the second end of the first swing arm 2 and the second swing arm 3 swing accordingly.

In specific embodiments, when the vehicle running board is in use, the first swing arm 2 and the second swing arm 3 may be attached to the vehicle through a fixed bracket 1, so that the vehicle running board is appended and used as a separate accessory that may be appended. The first swing arm 2 is movably connected to the fixed bracket 1 through the first rotating shaft 6, and the second swing arm 3 is movably connected to the fixed bracket 1 through the second rotating shaft 7. The fixed bracket 1 and the vehicle are provided with corresponding screw mounting holes, and the fixed bracket 1 may be attached and mounted on the vehicle through screw locking.

The running board bracket 5 is configured to be connected to the second end of the first swing arm 2 and the second end of the second swing arm 3. The running board bracket 5 connected to the second end of the first swing arm 2 and the second end of the second swing arm 3 may be driven to swing when the first end of the first swing arm 2 and the first end of the second swing arm 3 rotate around the axes where the first rotating shaft 6 and the second rotating shaft 7 are located, respectively, so that the running board bracket 5 makes extension or retraction motion.

In preferred embodiments, a swinging drive member may be provided to provide an external force to drive the first swing arm 2 and the second swing arm 3 to rotate around the axes where the first rotating shaft 6 and the second rotating shaft 7 are located, respectively. The swinging drive member may be, but not limited to, a motor. Moreover, the swinging drive member may be configured to be connected to the first swing arm 2 or the second swing arm 3 in an acting manner, or be connected to the first rotating shaft 6 or the second rotating shaft 7 in an acting manner. In specific embodiments, the swinging drive member may be a motor, and an output shaft of the motor is provided to be directly connected to the first rotating shaft 6. The first rotating shaft 6 is fixedly assembled with the first swing arm 2. When the motor is started, the first rotating shaft 6 may be driven to rotate, then the second end of the first swing arm 2 is driven to swing, and the second end of the second swing arm 3 synchronously swings due to link connection to the second end of the first swing arm 2.

When the running board bracket 5 is in an extension position, the first swing arm 2 is not parallel to the second swing arm 3, and the first swing arm 2 abuts against the second swing arm 3 to form self-locking, so that the running board bracket 5 may not be retracted by itself.

The running board body 11 is disposed on the running board bracket 5 and may make extension or retraction motion along with the swinging of the running board bracket 5. In specific embodiments, the running board bracket 5 is provided with a first end extending forward relative to the vehicle body and a second end facing away from the first end. The running board body 11 is specifically disposed at the first end of the running board bracket 5, and the second end of the running board bracket 5 is connected to the first swing arm 2 and the second swing arm 3. After the running board body 11 extends out in place, the running board body 11 is basically parallel to the horizontal plane for a person to step on conveniently to get on or off the vehicle. Specifically, the running board body 11 may be disposed on the running board bracket 5 in a manner of being fixed with respect to the running board bracket 5, for example, the running board body 11 is fixedly mounted on the running board bracket 5 in a locked manner through a locking member, or the running board body 11 is designed as a structure integrated with the running board bracket 5. In specific embodiments, the running board body 11 or the running board bracket 5 may be provided with a clamping groove, a slider 13 is in clamping fit with the clamping groove, and the slider 13 is locked to the running board bracket 5 or the running board body 11 through screws, so that the running board body 11 is fixedly mounted on the running board bracket 5 in a locked manner. Alternatively, the running board body 11 may be movably mounted on the running board bracket 5, and the running board body 11 may be interlocked with the running board bracket 5 through a corresponding clamping locking structure when extending out in place. The clamping relationship may be automatically released when the running board body is retracted.

The running board body 11 is provided with a running board tread 1101, and the running board tread 1101 is an upper surface, keeping basically parallel to the horizontal plane, of the running board body 11 when the running board body 11 extends out in place, and may be stepped on directly. Optionally, a surface of the running board tread 1101 may have a non-slip structure, such as non-slip lines arranged along a front-back direction of getting on or off the vehicle sequentially, to avoid slipping during stepping and provide use safety.

In preferred embodiments, the running board bracket 5 is connected to the second end of the first swing arm 2 and the second end of the second swing arm 3 through a movable bracket 4. The movable bracket 4 is movably connected to the second end of the first swing arm 2 and the second end of the second swing arm 3 through a third rotating shaft 8 and a fourth rotating shaft 9, respectively, so that the movable bracket 4 may rotate with respect to the first swing arm 2 and the second swing arm 3 around axes where the third rotating shaft 8 and the fourth rotating shaft 9 are located, respectively. The running board bracket 5 is connected to the movable bracket 4. When the first end of the first swing arm 2 and the first end of the second swing arm 3 rotate around the axes where the first rotating shaft 6 and the second rotating shaft 7 are located, respectively, the second end of the first swing arm 2 and the second end of the second swing arm 3 swing and drive the movable bracket 4 to swing synchronously, and the running board bracket 5 and the running board body 11 disposed on the running board bracket 5 may swing along with the movable bracket 4 synchronously to make extension or retraction motion. When the movable bracket 4 drives the running board bracket 5 to extend out in place, the first swing arm 2 and the second swing arm 3 form self-locking, and the movable bracket 4 may not retract by itself, so that the running board bracket 5 may not retract by itself either.

The running board bracket 5 is specifically configured to be movably connected to the movable bracket 4. A portion between the first end and the second end of the running board bracket 5 is connected to the movable bracket 4 through a fifth rotating shaft 10, so that the running board bracket 5 may rotate with respect to the movable bracket 4 around an axis where the fifth rotating shaft 10 is located. When the running board bracket 5 rotates around the axis where the fifth rotating shaft 10 is located, the running board body 11 disposed on the running board bracket 5 rotates along with the running board bracket 5 synchronously. Moreover, when the running board bracket 5 extends out in place, the running board bracket 5 is configured to abut against and be clamped to the movable bracket 4 in a relatively downward swinging direction, to limit the running board bracket 5 to continue to swing downward. In this case, the running board body 11 extending out in place is basically parallel to the horizontal plane, for example, after the running board body 11 extends out in place, an angle between a plane defined by the running board tread 1101 and the horizontal plane may be 1.5°, which ensures that the running board body 11 may bear loads exerted on the running board body 11 from top to bottom after extending out in place, and ensures that the running board body 11 may be stepped on for getting on or off the vehicle. In this way, after the running board body 11 extends out in place, when an outer side face of the running board body 11 with respect the vehicle is subjected to external forces, such as colliding with foreign matter, the running board body 11 may be turned upward and swing with respect to the movable bracket 4 along with the running board bracket 5 for cushioning, to prevent the running board body 11 from directly bearing the external impact, thereby reducing two-way damage to the running board body 11 and an collision object and prolonging the service life of the running board body 11.

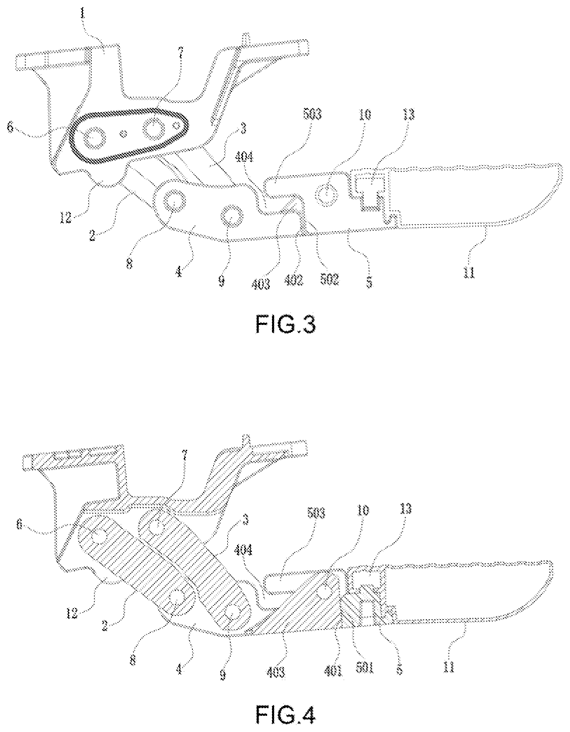

In specific embodiments, as shown in FIG. 2 to FIG. 4, the movable bracket 4 is provided with a mounting portion 403. The mounting portion 403 may specifically be an extension structure, extending out towards a side where the running board bracket 5 is located, on the movable bracket 4, and the running board bracket 5 is movably connected to the mounting portion 403 through the fifth rotating shaft 10. In addition, the movable bracket 4 is provided with a first abutting bearing surface 401 facing towards the running board bracket 5. The first abutting bearing surface 401 may specifically be located on a side, facing towards the running board bracket 5, of the mounting portion 403. The running board bracket 5 is provided with a second abutting bearing surface 501 corresponding to the first abutting bearing surface 401. Moreover, optionally, the first abutting bearing surface 401 is specifically located near a lower end of the movable bracket 4, and the second abutting bearing surface 501 is specifically located near a lower end of the running board bracket 5. When the running board bracket 5 extends out, the running board bracket 5 swings downward around the axis where the fifth rotating shaft 10 is located. After the running board bracket 5 extends out in place, the second abutting bearing surface 501 and the first abutting bearing surface 401 are in contact with each other, and the first abutting bearing surface 401 is directly clamped to the second abutting bearing surface 501 to limit the running board bracket 5 to continue to swing downward.

Therefore, when the running board bracket 5 extends out in place, the movable bracket 4 may not retract by itself due to the self-locking of the first swing arm 2 and the second swing arm 3 and is in a relatively stable state, and the running board bracket 5 abuts against the movable bracket 4 as the second abutting bearing surface 501 and the first abutting bearing surface 401 abut against each other, so that the running board bracket 5 may no not continue to swing downward, and accordingly the running board body 11 disposed on the running board bracket 5 is kept stable for steady stepping.

Further, the movable bracket 4 is further provided with first auxiliary bearing surfaces 402, and the first auxiliary bearing surfaces 402 may specifically be surfaces located on a left side and a right side of the mounting portion 403 and facing the running board bracket 5. The running board bracket 5 is provided with second auxiliary bearing surfaces 502 corresponding to the first auxiliary bearing surfaces 402, and the second auxiliary bearing surfaces 502 may specifically be disposed on a left side and a right side of the first abutting bearing surface 501. When the running board bracket 5 swings downward in place, the first abutting bearing surface 401 abuts against the second abutting bearing surface 501 to limit the running board bracket 5 to continue to swing downward, and at the same time, the first auxiliary bearing surfaces 402 abut against the second auxiliary bearing surfaces 502 to assist in limiting the running board bracket 5 to continue to swing downward, thereby further improving the stepping stability of the running board body 11.

In other preferred embodiments, as shown in FIG. 1 and FIG. 2, the vehicle running board according to the present disclosure is provided with the exciting member 12. The exciting member 12 is configured to act on the running board bracket 5, and the running board bracket 5 may rotate around the axis where the fifth rotating shaft 10 is located under the exciting action of the exciting member 12. When the movable bracket 4 drives the running board bracket 5 to retract, the exciting member 12 may selectively excite the running board bracket 5 to enable the running board bracket 5 to continue to swing upward, so that the running board body 11 mounted on the running board bracket 5 is further turned upward, the angle between the plane defined by the running board tread 1101 and the horizontal plane is increased, for example, the angle between the plane defined by the running board tread 1101 and the horizontal plane may reach 18.2°, and the running board body 11 is closer to the bottom side face of the vehicle body, thereby avoiding the situation that the running board body 11 is prone to colliding with obstacles to be damaged in the running process as the height is too low, and improving the overall appearance of the retracted running board body 11 and the vehicle body.

Specifically, based on the selection of the exciting member 12, the exciting member 12 may specifically achieve the action relationship with different portions of the running board bracket 5 to drive the running board bracket 5 to rotate around the axis where the fifth rotating shaft 10 is located. Optionally, the exciting member 12 may be a drive component with an autonomous exciting effect, such as a motor, or may be a block with a non-autonomous exciting effect, such as a fixed block, a roller or a fixed rod. Moreover, the exciting member 12 may select to achieve the action relationship with the first end or the second end of the running board bracket 5. Alternatively, the running board bracket 5 is fixedly assembled with the fifth rotating shaft 10, and the exciting member 12 selects to achieve the action relationship with the fifth rotating shaft 10 and drives the running board bracket 5 to rotate by selecting to drive the fifth rotating shaft 10.

For example, in preferred embodiments, the exciting member 12 is selected as a drive element having a rotation drive effect, including a motor, etc. The exciting member 12 may be mounted on the mounting portion 403 or a body of the movable bracket 4. An output end of the exciting member 12 is connected to the first end or the second end of the running board bracket 5 in an acting manner, or is connected to the portion between the first end and the second end of the running board bracket 5 in an acting manner, or is connected to the fifth rotating shaft 10 in an acting manner, the running board bracket 5 and the fifth rotating shaft 10 are fixedly assembled, and the running board bracket 5 may rotate along with rotation of the fifth rotating shaft 10. Thus, when the exciting member 12 is started, the running board bracket 5 may be driven to rotate around the axis where the fifth rotating shaft 10 is located.

For example, in other preferred embodiments, the exciting member 12 is selected as a block with a non-autonomous exciting effect, such as a fixed block, a roller or a fixed rod. The exciting member 12 may select to be disposed on the second swing arm 3 or the fixed bracket 1 or an equivalent structure in the vehicle, and corresponds to the first end of the running board bracket 5. Moreover, the exciting member 12 may be fixed or movable. When the running board bracket 5 moves along with the movable bracket 4 from the extension position to the retraction position, the exciting member 12 may abut against the first end of the running board bracket 5 during at least part of the travel to enable the running board bracket 5 to rotate around the axis where the fifth rotating shaft 10 is located, and then the second end of the running board bracket 5 tilts upward to drive the running board body 11 mounted at the second end of the running board bracket 5 to tilt upward synchronously to be turned over, so that the running board tread 1101 of the running board body 11 is turned over to a position where the running board tread is basically parallel to the horizontal plane when stepped, and the running board body 11 is retracted in place when turned over in place.

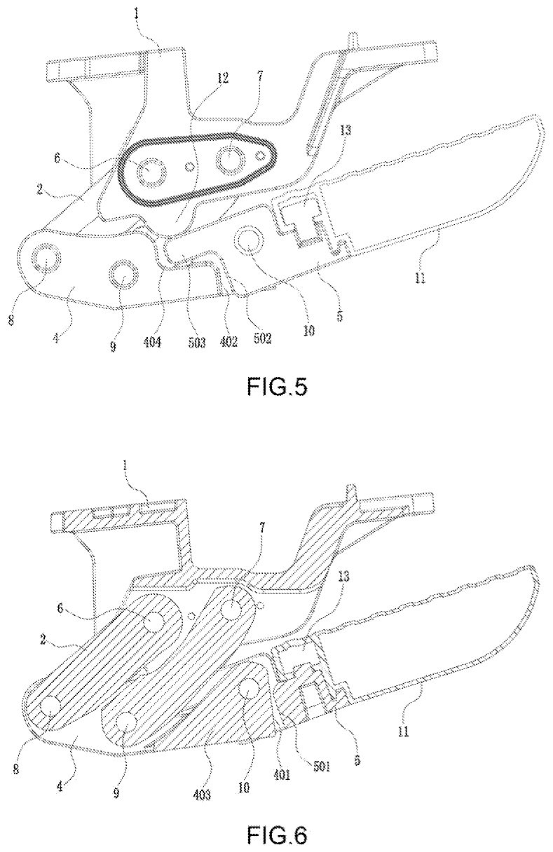

In specific embodiments, as shown in FIG. 1 to FIG. 6, the first end of the running board bracket 5 is provided with an exciting action arm 503. The exciting action arm 503 is specifically an integrated extension arm on the running board bracket 5, and the running board body 11 is disposed at the second end of the running board bracket 5. The fixed bracket 1 is provided with the exciting member 12, and the exciting member 12 is specifically a fixed block with a non-autonomous exciting effect. When the running board bracket 5 moves along with the movable bracket 4 from the extension position to the retraction position, the exciting action arm 503 may move towards the exciting member 12 and abut against the exciting member 12, so that the exciting member 12 drives the running board bracket 5 to rotate around the axis where the fifth rotating shaft 10 is located.

The position where the exciting action arm 503 is provided may be designed and adjusted based on a turnover angle of the running board body 11. For example, in some specific embodiments, the exciting action arm 503 may extend out from a position near an upper end of the running board bracket 5, or from a middle position of the running board bracket 5, or from a position near the lower end of the running board bracket 5. In addition, the extension length of the exciting action arm 503 may be designed and adjusted based on a turnover angle of the running board body 11. For example, in some specific embodiments, the exciting action arm 503 may extend to begin to abut against the exciting member 12 when the running board bracket 5 begins to retract. Alternatively, the exciting action arm 503 may extend to begin to abut against the exciting member 12 at a position in the retraction process of the running board bracket 5 from the extension position to the retraction process. When the exciting action arm 503 extends out from the position near the upper end of the running board bracket 5 and is designed to have a sufficient length, the running board body 11 has a large turnover angle.

In the preferred embodiments shown, the exciting member 12 is fixedly disposed on the fixed bracket 1, and the exciting member 12 is preferably a fixed block or a moving roller. More specifically, the exciting member 12 is preferably a raised structure integrated with the fixed bracket 1 on the fixed bracket 1, and the raised structure protrudes downward. A surface, in contact with the exciting action arm 503, of the raised structure is a curved convex surface. When the running board bracket 5 moves along with the movable bracket 4 from the extension position to the retraction position, the exciting action arm 503 moves towards the exciting member 12 and abuts against the exciting member 12. In the process that the running board bracket 5 moves to continue to retract along with the movable bracket 4, a contact point of the exciting member 12 and the exciting action arm 503 gradually moves towards the second end of the running board bracket 5 along with movement of the exciting action arm 503 towards the retraction position, and thus the second end of the running board bracket 5 gradually tilts upward.

The curved convex surface of the exciting member 12 may be a curved convex surface with stable curvature, so as to keep stable contact with and stably driving the exciting action arm 503. Further, in the process that the running board bracket 5 moves to continue to retract along with the movable bracket 4, an upper end face, in contact with the exciting member 12, of the exciting action arm 503 may be designed as a plane or a surface in other shape, preferably, a plane. Furthermore, when the exciting action arm 503 is designed as a short extension arm that begins to abut against the exciting member 12 at a position in the retraction process of the running board bracket 5 from the extension position to the retraction process, the end of the exciting action arm 503 may be designed as a curved surface, so that the contact between the exciting action arm and the exciting member 12 may smoothly transition to the upper end without abrupt change.

Further, the movable bracket 4 has an avoidance position 404. The avoidance position 404 may specifically be a concave part between the body of the movable bracket 4 and the mounting portion 403. When the exciting action arm 503 abuts against the exciting member 12 and swings downward, the exciting action arm 503 may enter the avoidance position 404 to avoid the swinging of the exciting action arm 503, thereby ensuring smooth swinging of the exciting action arm 503.

The above embodiments are merely preferred embodiments of the present disclosure and are intended only to describe the technical solutions of the present disclosure in further detail. However, the above description is exemplary and not exhaustive, and is not limited to the disclosed embodiments. The scope of protection and implementation of the present disclosure are not limited thereto. Any changes, combinations, deletions, replacements, or modifications made without departing from the spirit and principle of the present disclosure shall fall within the scope of protection of the present disclosure.

1. A vehicle running board, comprising a first swing arm, a second swing arm, a movable bracket, a running board bracket, an exciting member, and a running board body,
wherein
when in use, a first end of the first swing arm and a first end of the second swing arm are rotatably attached to a vehicle, the first end of the first swing arm being rotatable around a first axis, and the first end of the second swing arm being rotatable around a second axis; the movable bracket is connected to a second end of the first swing arm and a second end of the second swing arm, and is rotatable around a third axis and a fourth axis respectively with respect to the first swing arm and the second swing arm; the movable bracket is configured to make extension or retraction motion between a retraction position and an extension position;
the running board bracket is movably connected to the movable bracket, and is rotatable around a fifth axis under the exciting action of the exciting member; and the running board body is disposed on the running board bracket.

2. The vehicle running board according to claim 1, wherein the exciting member corresponds to a first end of the running board bracket, and the running board body is disposed at a second end of the running board bracket; the first end and the second end of the running board bracket are rotatable around the fifth axis; and the exciting member acts on the first end of the running board bracket to drive the running board bracket to rotate.

3. The vehicle running board according to claim 2, wherein when the run no board bracket moves along with the moveable bracket from extension position to the retraction position, the exciting member abuts against the first end of the running board enable the running board bracket to rotate around the fifth axis.

4. The vehicle running board according to claim 1, further comprising a fixed bracket, wherein when in use, the first swing arm and the second swing arm are attached to the vehicle through the fixed bracket; and
the first end of the first swing arm and the first end of the second swing arm are movably connected to the fixed bracket and are rotatable around the first axis and the second axis respectively.

5. The vehicle running board according to claim 4, wherein the exciting member corresponds to a first end of the running board bracket, and the running board body is disposed at a second end of the running board bracket; the first end and the second end of the running board bracket are rotatable around the fifth axis; and the exciting member acts on the first end of the running board bracket to drive the running board bracket to rotate.

6. The vehicle running board according to claim 5, wherein when the running board bracket moves along with the movable bracket from the extension position to the retraction position, the exciting member abuts against the first end of the running board bracket to enable the running board bracket to rotate around the fifth axis.

7. The vehicle running board according to claim 1, wherein a first end of the running board bracket has an exciting action arm, and the running board body is disposed at a second end of the running board bracket; and when the running board bracket moves along with the movable bracket from the extension position to the retraction position, the exciting action arm moves close to the exciting member and abuts against the exciting member, and the exciting member drives the running board bracket to rotate around the fifth axis.

8. The vehicle running board according to claim 1, further comprising a fixed bracket, wherein when in use, the first swing arm and the second swing arm are attached to the vehicle through the fixed bracket; and the first end of the first swing arm and the first end of the second swing arm are movably connected to the fixed bracket and are rotatable around the first axis and the second axis respectively.

9. The vehicle running board according to claim 8, wherein a surface, in contact with the exciting action arm, of the exciting member is a curved surface.

10. The vehicle running board according to claim 8, wherein the exciting member is a raised structure integrated with the fixed bracket on the fixed bracket.

11. The vehicle running board according to claim 7, wherein the exciting member is fixed.

12. The vehicle running board according to claim 11, further comprised a fixed bracket, wherein when in use, the first swing arm and the second swing arm are attached to the vehicle through the fixed bracket; and the first end of the first swing arm and the first end of the second swing arm are movably connected to the fixed bracket and are rotatable around the first axis and the second axis respectively.

13. The vehicle running board according to claim 12, wherein the exciting member is located on the fixed bracket.

14. The vehicle running board according to claim 13, wherein the exciting member is a raised structure integrated with ne fixed bracket on the fixed bracket.

15. The vehicle running board according to claim 7, wherein a surface, in contact with the exciting action arm, of the exciting member is a curved surface.

16. The vehicle running board according to claim 15, further comprised a fixed bracket, wherein when in use, the first swing arm and the second swing arm are attached to the vehicle through the fixed bracket; and the first end of the swing arm and the first end of the second swing arm are movably connected to the fixed bracket and are rotatable around the first axis and the second axis respectively.

17. The vehicle running board according to claim 16, wherein the exciting member is located on the fixed bracket.

18. The vehicle running board according to claim 17, wherein the exciting member is a raised structure integrated with the fixed bracket on the fixed bracket.

19. The vehicle running board according to claim 7, wherein a surface, in contact with the exciting action arm, of the exciting member is a curved convex surface.

20. The vehicle running board according to claim 7, wherein the movable bracket has an avoidance position to avoid swinging of the exciting action arm.

21. The vehicle running board according to claim 1, further comprising a rotation drive member, the rotation drive member being capable of driving the running board bracket to rotate around the fifth axis.

22. The vehicle running board according to any claim 1, wherein the movable bracket and the running board bracket are provided with corresponding abutting surfaces; and when the running board bracket extends out in place, the movable bracket abuts against the running board bracket.

23. The vehicle running board according to claim 1, wherein the movable bracket is provided with a mounting portion extending towards the running board bracket, and the running board bracket is movably mounted on the mounting portion of the movable bracket.

24. The vehicle running board according to claim 1, further comprising a swinging drive member, the swinging drive member being capable of driving the first swing arm or the second swing arm to rotate and swing.
